(19) United States
(12) Patent Application Publication
(10) Pub. No.: US 2013/0232144 A1
(43) Pub. Date: Sep. 5, 2013

(54) MANAGING STORYBOARDS

(71) Applicants: SONY CORPORATION, Tokyo (JP); SONY PICTURES TECHNOLOGIES, INC., Culver City, CA (US)

(72) Inventors: Yiotis Katsambas, Encino, CA (US); Dave Morehead, Los Angeles, CA (US); Umberto Lazzari, Los Angeles, CA (US)

(73) Assignees: SONY PICTURES TECHNOLOGIES, INC., Culver City, CA (US); SONY CORPORATION, Tokyo (JP)

(21) Appl. No.: 13/771,019

(22) Filed: Feb. 19, 2013

Related U.S. Application Data
(60) Provisional application No. 61/605,502, filed on Mar. 1, 2012.

(51) Int. Cl. G06F 17/30

(52) U.S. Cl. CPC G06F 17/30312
USPC 707/736

(57) ABSTRACT

Managing assets in a movie during production, including: storing an image file in a temporary location; storing an XML file containing various metadata; sending a signal including the path the XML filet wherein the XML file contains a path to the image file that it is to be imported. Keywords include Photoshop and XML.

### CROSS-REFERENCE TO RELATED APPLICATIONS

This application claims the benefit of priority under 35 U.S.C. §119(e) of co-pending U.S. Provisional Patent Application No. 61/605,502, filed Mar. 1, 2012, entitled “Managing Storyboards.” The disclosure of the above-referenced application is incorporated herein by reference.

### BACKGROUND

1. Field of the Invention

The present invention relates to asset management, and more specifically, to managing storyboards in content production.

2. Background

In the process of making a movie, a storyboard is a pre-production process that is used to visualize scenes in detail. The storyboard expresses an image to be delivered as an illustration according to a sequence, illustrates a motion of camera and/or subject for each scene by visualizing the image to be presented to an audience and a customer. For example, the storyboarding process involves many panels of images drawn by a story artist, and presented in order for the purpose of visualizing sections of a motion picture prior to production. Typically, a completed storyboard includes the information that all staff, such as a producer, a director, and an art director may use to understand how to construct the corresponding story.

### SUMMARY

The present invention provides for managing storyboards in content production.

In one implementation, a method of managing assets during production of a movie is disclosed. The method includes: storing an image file in a temporary location; storing an XML file containing various metadata; sending a signal including the path the XML filet wherein the XML file contains a path to the image file that it is to be imported.

In another implementation, a system for managing storyboards is disclosed. The system includes: a non-transitory memory configured to receive and store an XML file containing various metadata created by at least one storyboard artist, wherein the metadata includes information about an image file generated in a content processing tool; and a processor configured to parse the XML file to process the image file, and generate and format a new shot to specific needs of a project.

In yet another implementation, a non-transitory storage medium storing a computer program to manage assets during production of a movie is disclosed. The computer program includes executable instructions that cause a computer to: store an image file in a temporary location; store an XML file containing various metadata; send a signal including the path the XML filet wherein the XML file contains a path to the image file that it is to be imported.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a flowchart illustrating an asset management process in accordance with one implementation of the present invention.

FIG. 2 is a functional block diagram of an asset management system in accordance with one implementation of the present invention.

FIG. 3A illustrates a representation of a computer system and a user.

FIG. 3B is a functional block diagram illustrating the computer system hosting the asset management process.

### DETAILED DESCRIPTION

Certain implementations as disclosed herein provide a technique for managing storyboards in content production. In one implementation, a computer system helps to manage storyboarding, such as by improving the interaction with an application like Photoshop. Features provided in the implementations enable the artists to quickly and efficiently share their ideas, and automatically organize and/or pre-process the files. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

Content processing tools such as Photoshop, Maya, Avid, and Nuke are applications that are commonly used by storyboard artists (including editorial personnel, production coordinators, story supervisors, layout supervisors, directors, etc.). As part of their workflow, artists often make use of layers in a content processing tool (e.g., a Photoshop layer). A single digital file (e.g., a Photoshop file) might contain multiple storyboard panels. One of the most time consuming parts of the storyboarding phase, is splitting up, organizing and tracking the individual storyboard panels once they are created.

In one implementation, a new storyboard management system automatically manages the organization of storyboards by allowing the artists to send their storyboard panels directly from a content processing tool (e.g., Photoshop) to a software application of the storyboard management system. Aside from organizing panels, the storyboard management system automatically determines which layers are needed for each storyboard panel, and only stores the layers that are visible.

In one implementation, the system automates the organization of files generated in the content processing tool (e.g., Photoshop). Initially, an artist can draw a storyboard panel. Once the drawing is ready to be sent to the software application of the storyboard management system, the user triggers one of the scripts of the content processing tool through the use of a keyboard shortcut, or a menu selection, and the active drawing is automatically sent to the software application of the storyboard management system.

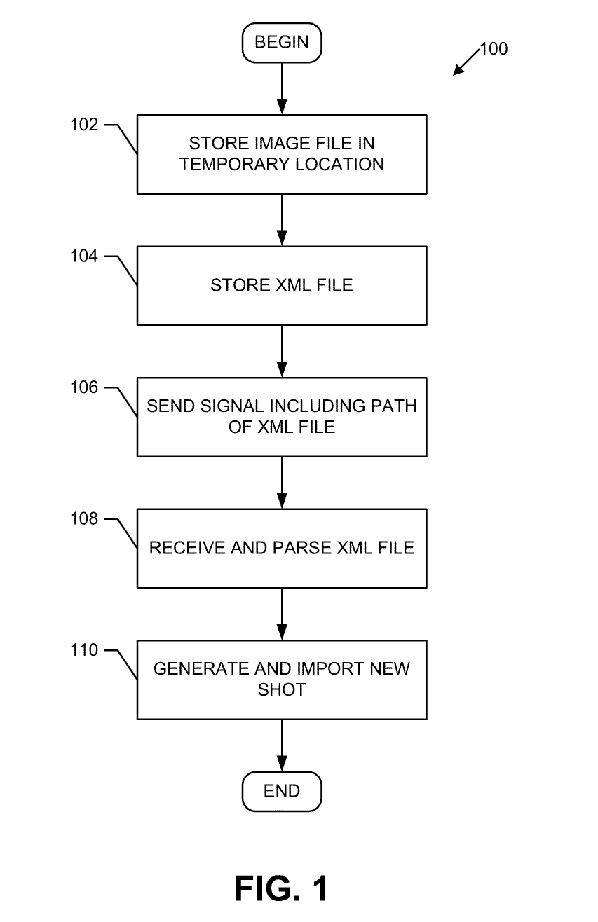

FIG. 1 is a flowchart illustrating an asset management process 100 in accordance with one implementation of the present invention. In this implementation, the process 100 automates the organization of storyboard panel(s) generated in the content processing tool (e.g., Photoshop). Once the panel(s) is ready to be sent to the storyboard management system, the user triggers one of the scripts of the content processing tool through the use of a keyboard shortcut or a menu selection, and the active drawing is automatically sent to the software application of the storyboard management system. Although the process 100, in the illustrated implementation, is used to manage, develop and/or analyze a story in motion picture, this technique can be modified to be used to develop and/or analyze a story in other areas, such as in computer games, commercials, TV shows, music videos, theme park rides, and in forensic visualization.

In the illustrated implementation of FIG. 1, the asset management process 100 includes storing an image file in a temporary location, at box 102. In one implementation, the image file includes a storyboard panel. In another implementation, the image file includes a sequence of storyboard panels. An XML file containing various metadata about the image file is stored, at box 104. In one implementation, the metadata includes resolution, and any dialogue that might accompany the image file. A signal including the path of the XML file is then sent, at box 106, to the software application of the storyboard management system, wherein the XML file contains a path to the image file that is to be imported.

The software application's listener (of the storyboard management system) receives the call about a new file and parses the XML file, at box 108. It then automatically runs through a process, at box 110, of generating a new shot, formatting the image to the specific needs of the project, and importing it into the storyboard management system. In one implementation, the new shot is placed right after the currently-selected shot in the software application, and the new shot is automatically selected. The artist can continue to draw panels and send them to the software application by repeating the above process thus, creating a sequence of storyboard panels.

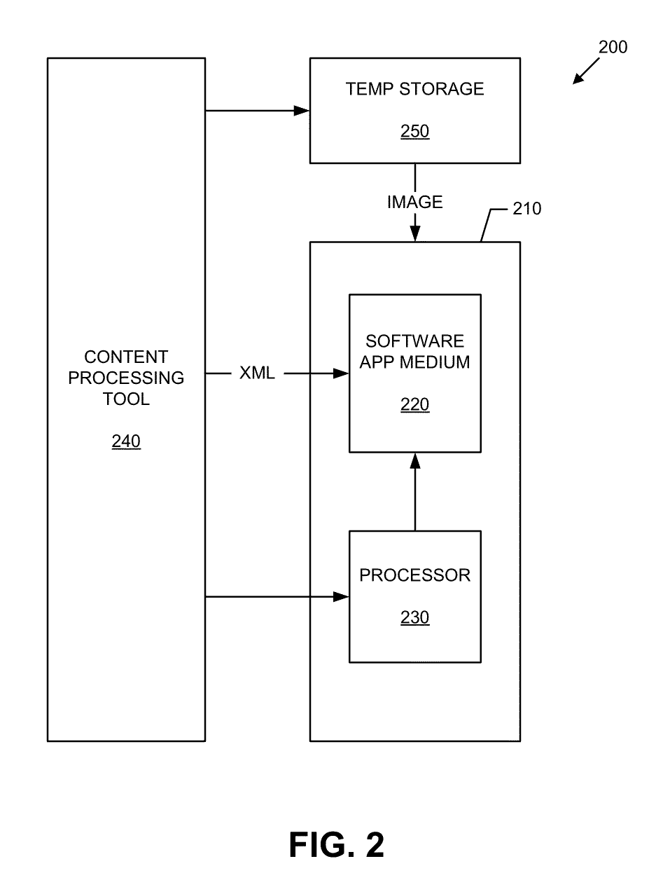

FIG. 2 is a functional block diagram of an asset management system 200 in accordance with one implementation of the present invention. The asset management system 200 includes a storyboard management system 210, a content processing tool 240, and temporary storage 250. Further, the storyboard management system 210 includes a non-transitory storage medium 220 storing a software application and a processor 230.

In the illustrated implementation of FIG. 2, the asset management system 200 is configured to automate the organization of storyboard panel(s) generated by the content processing tool 240. Once the panel(s) is ready to be sent to the storyboard management system 210, the user triggers one of the scripts of the content processing tool 240, and the active drawing is automatically sent to the non-transitory storage medium 220 storing the software application. Further, an image file from the content processing tool 240 is stored in a temporary location 250. A user may trigger one of the scripts of the content processing tool 240 to store an XML file containing various metadata about the image file in the non-transitory storage medium 220. A signal including the path of the XML file may then be sent to the processor 230. In one implementation, the XML file contains a path to the image file that is to be imported. The processor 230 parses the XML file once it receives a call about the XML file. The processor 230 then automatically runs through a process of generating a new shot, formatting the image to the specific needs of the project, and importing it into the storyboard management system. In one implementation, the new shot is placed right after the currently-selected shot in the software application stored in the non-transitory storage medium 220, and the new shot is automatically selected.

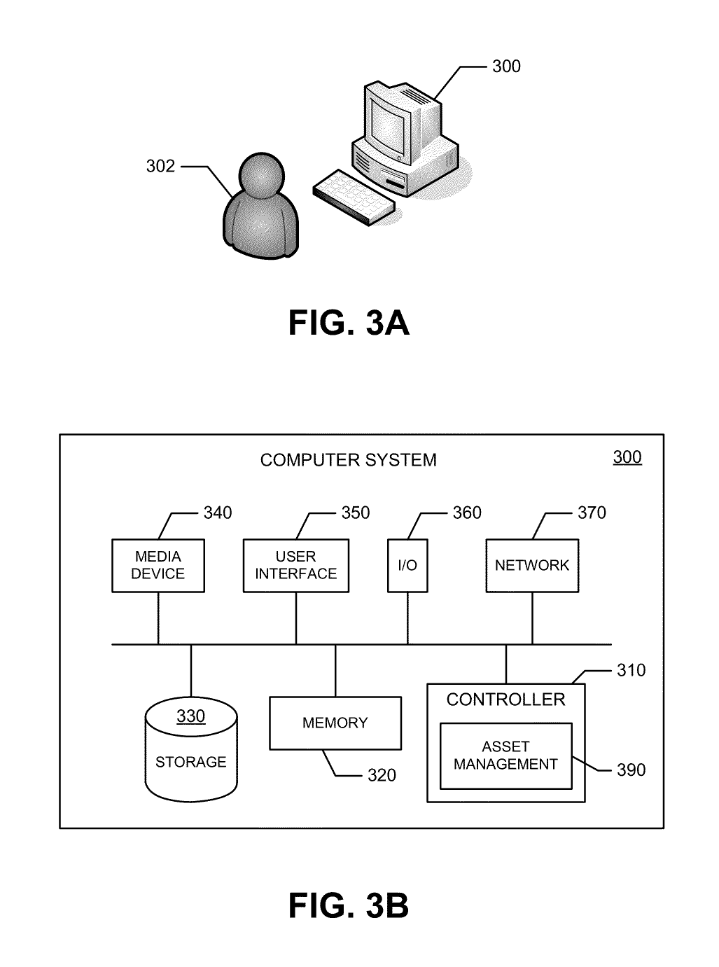

FIG. 3A illustrates a representation of a computer system 300 and a user 302. The user 302 uses the computer system 300 to perform various operations described with respect to FIGS. 1 and 2. Thus, the computer system 300 includes an asset management process 390 which is similar to the process 100 described in FIG. 1.

FIG. 3B is a functional block diagram illustrating the computer system 300 hosting the asset management process 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the asset management process 390 as a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Non-transitory storage 330 stores data for use by other components of the computer system 300, such as for storing data used by the asset management process 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user 302 and presenting information to the user 302. In one implementation, the user interface 350 includes a keyboard, a mouse, audio speakers, and a display. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 802.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, following variations are possible: alternate ways of managing layers in Photoshop which allow the artists to draw multiple panels within the same Photoshop file; considering each layer as a single panel, wherein multiple image files are saved, and each image file represents a layer; considering each animation timeline panel as a single panel, wherein only the relevant layers are saved for each exported image file; considering each layer except the most bottom layer as a single panel, while the bottom layer is used as a common background layer for each other layer, wherein only the relevant layers are saved for each exported panel; considering each layer-comp as layer, wherein only the relevant layers are saved for each exported file; arguments in the XML file allow the importing of multiple shots; arguments in the XML file allow the importing of animated sequences; arguments in the XML file can indicate shots that replace existing shots as opposed to importing new ones; arguments in the XML can indicate that a shot is a new version of an existing shot (the software application will create a new shot to replace the existing shot and will be marked as new version of the original shot); and arguments in the XML can contain metadata that can be stored as part of the shot.

Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of managing assets in a movie during production, comprising:
storing an image file in a temporary location;
storing an XML file containing various metadata;
sending a signal including the path the XML filet wherein the XML file contains a path to the image file that it is to be imported.

2. The method of claim 1, wherein the XML file also contains metadata which includes resolution, and any dialogue that might accompany the image file.

3. The method of claim 1, wherein the XML file containing the metadata is generated in a content processing tool.

4. The method of claim 1, wherein the image file includes a storyboard panel.

5. The method of claim 1, further comprising parsing the XML file.

6. The method of claim 1, further comprising:
generating a new shot;
formatting the new shot to a specific need of a project; and
importing the new shot into a storyboard management system.

7. The method of claim 6, wherein the new shot is placed right after a currently-selected shot in the storyboard management system.

8. A storyboard management system, comprising:
a non-transitory memory configured to receive and store an XML file containing various metadata created by at least one storyboard artist,
wherein the metadata includes information about an image file generated in a content processing tool; and
a processor configured to parse the XML file to process the image file, and generate and format a new shot to specific needs of a project.

9. The storyboard management system of claim 8, wherein the image file is generated by the content processing tool and stored in a temporary location.

10. The storyboard management system of claim 8, wherein the new shot is placed right after a currently-selected shot, and the new shot is automatically selected.

11. A non-transitory storage medium storing a computer program to manage assets during production of a movie, the computer program comprising executable instructions that cause a computer to:
store an image file in a temporary location;
store an XML file containing various metadata;
send a signal including the path the XML filet wherein the XML file contains a path to the image file that it is to be imported.

12. The non-transitory storage medium of claim 11, wherein the XML file also contains metadata which includes resolution, and any dialogue that might accompany the image file.

13. The non-transitory storage medium of claim 11, wherein the XML file containing the metadata is generated in a content processing tool.

14. The non-transitory storage medium of claim 11, wherein the image file includes a storyboard panel.

15. The non-transitory storage medium of claim 11, further comprising executable instructions that cause a computer to parse the XML file.

16. The non-transitory storage medium of claim 11, further comprising executable instructions that cause a computer to:
generate a new shot;
format the new shot to a specific need of a project; and
import the new shot into a storyboard management system.

17. The non-transitory storage medium of claim 16, wherein the new shot is placed right after a currently-selected shot in the storyboard management system.
